(19) United States
(12) Patent Application Publication
(10) Pub. No.: US 2008/0212780 A1
(43) Pub. Date: Sep. 4, 2008

(54) Homomorphic Encryption For Secure Watermarking

(75) Inventors: Aweke Negash Lemma, Eindhoven (NL); Minne Van Der Venn, Eindhoven (NL); Pim Theo Tuyls, Eindhoven (NL); Antonius Andrianus Cornelis Maria Kalker, Mountain View, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,744

(22) PCT Filed: Jun. 2, 2006
(86) PCT No.: PCT/IB2006/051773

§ 371 Date: Nov. 28, 2007

(30) Foreign Application Priority Data
Jun. 3, 2005 (EP) 05104828.8

(51) Int. Cl. H04L 9/14

(52) U.S. Cl. 380/277

(57) ABSTRACT

A method and a system for embedding a watermark in a media signal x are disclosed. The method comprises providing an at least partially encrypted media signal cₓ of said media signal x, wherein encryption is performed using a first encryption key k1; providing an at least partially encrypted watermark signal c_{w}, wherein encryption is performed using a second encryption key k₂; combining the at least partially encrypted media signal cₓ and the at least partially encrypted watermark signal c_{w} in a combiner to obtain an encrypted combined media signal c_{y}; and obtaining a decrypted watermarked media signal y by decrypting said encrypted combined media signal c_{y} using a third decryption key k3. The present invention provides a framework for secure watermark embedding within untrusted devices.

### FIELD OF THE INVENTION

This invention pertains in general to the field of secure transmission of data. More particularly the invention relates to a method and arrangement for embedding a watermark in a media signal in an electronic music delivery system and more particularly to homomorphic encryption for secure watermarking in an electronic music delivery system.

### BACKGROUND OF THE INVENTION

A conventional electronic music distribution (EMD) system 100 for distributing music data is illustrated in FIG. 1. The EMD system 100 comprises a server 102, a client 118 and a distribution network 116 such as the Internet. In general, the server 102 encrypts content data and content information such as copyright information by using session key data obtained after performing mutual authentication between the content provider and a user who has requested the content via the distribution network 116. The encrypted information is transferred to the client 118 who then decrypts the encrypted information to obtain the requested content.

More specifically, after the request for content, sent from the client 118 to the server 102 via the network 116, has been authenticated, the content provider 104 sends the requested content 106 to a watermark engine 110 and sends the content information 108 to a payload device 112. The content information 108 may include serial copy management system (SCMS) information, digital watermark information for embedding copyright information into the content data and information for embedding copyright information into transmission protocols of the server 102.

The payload device 112 computes the appropriate payload to be embedded and transfers the payload pL to the watermark engine 110. The watermark engine embeds the payload pL into the content 106. The combined data from the watermark engine 110 is then encrypted by an encryption device 114. The combined data is conventionally encrypted by a single encryption key. The encrypted signal E(y) is then sent to the client 118 over the Internet 116. The client 118 then decrypts the encrypted signal E(y) in a decryption device 120. The watermarked but decrypted content is then stored in a user database 122 for use by the user.

Presently, the server processes run at about 40 times real time on a 3 GHz Pentium IV processor. Though this is acceptable in many instances, it may not be sufficient for mass content distribution requiring millions of simultaneous accesses. In this case, a fixed low complexity server is desirable with the possibility for multi-casting and caching. These and other features desired to have implemented, such as service flexibility, can be achieved if the watermark embedding is done at the client side. Generally however, client side embedding will make the watermarking system vulnerable to hacking and should therefore be avoided. Particularly, if the client is allowed to possess both the watermarked and non-watermarked contents, it is extremely easy to maliciously remove or modify the watermark and even to estimate the underlying algorithm. In conclusion, there is a need for a client-side embedding that is implemented by providing a cryptographically secure embedding solution.

One solution for secure watermark embedding, also referred to as watercrypt, is disclosed in “Large scale distributed watermarking of multicast media through encryption” by Roland Parviainen and Peter Parnes, presented at the CMS2001 conference, Darmstadt, Germany. The idea there is to have two encrypted media streams x₁ and x₂, equipped with watermarks w₁ and w₂, respectively. Encryption and watermarking is done on a frame-by-frame (packet) basis, i.e. having one packet it is possible to extract either watermark w₁ or w₂. Every packet is encrypted with a different key Kₑ[i]. Therefore, a total of 2k random encryption keys Kₑ[1], Kₑ[2], . . . , Kₑ [2k] is required. Both x₁ and x₂ are transmitted to every user.

Each user is given a unique sequence of decryption keys K_{d}[i] which determines the sequence in which the signals x₁ and x₂ are decrypted. If x₁ and x₂ are encoded as binary “0” and “1”, a total of N=k bit information can be carried with such a watermark. The shortcoming of this approach is that two parties can easily combine two decrypted sequences, just by concatenating alternating segments, to generate either invalid payload or a new valid payload pointing to another client. Such an attack can compromise the entire system and makes the algorithm inapplicable to applications such as EMD.

Another framework that can be used for embedding a watermark in a secure domain is disclosed in “Processing Encrypted Data” by Niv Ahituv, Yeheskel Lapid, and Seev Neumann, Communications of the ACM, Volume 30 no. 9, 1987. In this article, an idea of processing encrypted data for the purpose of updating the balance of certain bank accounts by subtraction or addition is discussed. They suggest to use homomorphic encryption functions satisfying the rules:

E_{k1,k2}(A+B)=Eₖ₁(A)+Eₖ₂(B), and

Eₖ(axB)=Eₖ(A)xa.

This solution however lacks an actual implementation based on specific algorithms. Moreover, the disclosed method assumes a modulo arithmetic and does not work under overflow conditions.

Hence, an improved method for embedding watermarks would be advantageous and in particular a method and system allowing for securely embedding a watermark at the un-trusted client-side of a distribution system would be advantageous.

### SUMMARY OF THE INVENTION

Accordingly, the present invention preferably seeks to mitigate, alleviate or eliminate one or more of the above-identified deficiencies in the art and disadvantages singly or in any combination and solves at least the above mentioned problems, at least partly, by providing a device, a method, a computer-readable medium, and a media signal that securely embeds a watermark at the client side of a distribution system, according to the appended patent claims.

The general solution according to the invention provides a framework for secure watermark embedding within un-trusted devices.

According to aspects of the invention, a method, an apparatus, and a computer-readable medium for embedding a watermark in a media signal in a device are disclosed.

According to one aspect of the invention, a method is provided for embedding a watermark in a media signal in a device. The method comprises: providing an at least partially encrypted media signal of the media signal, wherein encryption is performed using a first encryption key k1; providing an at least partially encrypted watermark signal, wherein encryption is performed using a second encryption key k2; combining the at least partially encrypted media signal and the at least partially encrypted watermark signal in a combiner to obtain an encrypted combined media signal; and obtaining a decrypted media signal by decrypting said encrypted combined media signal using a third decryption key k3.

According to another aspect of the invention, a system is provided for embedding a watermark in a media signal in a device. The system comprises: means for providing an at least partially encrypted media signal of the media signal, wherein encryption is performed using a first encryption key k1; means for providing an at least partially encrypted watermark signal, wherein encryption is performed using a second encryption key k2; means for combining the at least partially encrypted media signal and the at least partially encrypted watermark signal in a combiner to obtain an encrypted combined media signal; and means for obtaining a decrypted media signal by decrypting said encrypted combined media signal using a third decryption key k3.

According to a further aspect of the invention, a computer-readable medium having embodied thereon a computer program for embedding a watermark in media signal in a device, for processing by a computer is provided. The computer program comprises: a first code segment for providing an at least partially encrypted media signal of said media signal, wherein encryption is performed using a first encryption key k1; a second code segment for providing an at least partially encrypted watermark signal, wherein encryption is performed using a second encryption key k2; a third code segment for combining the at least partially encrypted media signal and the at least partially encrypted watermark signal in a combiner to obtain an encrypted combined media signal; and a fourth code segment for obtaining a decrypted watermarked media signal y by decrypting said encrypted combined media signal using a third decryption key k3.

According to yet another aspect of the invention, a media signal is provided. More specifically, an encrypted combined media signal is provided, comprising in combination an at least partially encrypted media signal of a media signal, wherein encryption is performed using a first encryption key k1, and an at least partially encrypted watermark signal, wherein encryption is performed using a second encryption key k2; wherein said combination signal is decryptable in order to provide a decrypted media signal by decrypting said encrypted combined media signal using a third decryption key k3, such that said media signal has a decrypted watermark embedded therein.

The present invention has at least the advantage over the prior art that it allows for the content to be watermarked at the client-side of a distribution system without the risk of the client being able to remove the watermark from the content received by the client, even if the client is untrusted.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 is a schematic diagram of a known electronic music delivery system;

FIG. 2 is a schematic diagram of an electronic music delivery system according to one embodiment of the invention;

FIG. 3 is a flow chart illustrating homomorphic cryptography using the Paillier method according to another embodiment of the invention;

FIG. 4 is a flow chart illustrating homomorphic cryptography using the El Gamal method according to yet another embodiment of the invention; and

FIG. 5 illustrates a computer readable medium according to a further embodiment of the invention.

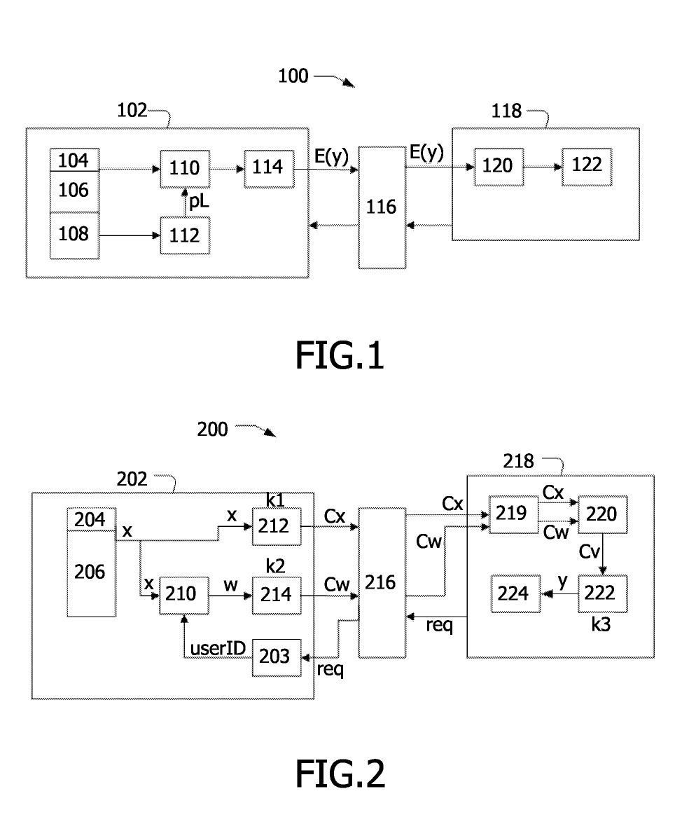

### DESCRIPTION OF EMBODIMENTS

The following description focuses on a embodiments of the present invention applicable to an electronic music delivery system. However, it will be appreciated that the invention is not limited to this application but may be applied to many other distribution systems which employ watermarking techniques, e.g. image databases or the like. FIG. 2 illustrates the basic architecture of an electronic music delivery (EMD) system 200 according to one embodiment of the invention. Although the solution discussed hereafter is based on the EMD architecture of FIG. 2, the same principle can also be applied to many other applications. In the EMD context, we make the following assumptions. We have a media distribution service consisting of a server and a client. The server is trusted and the client is not trusted. The client should not have access to non-watermarked content nor the watermark signal. The invention is of course applicable to all systems fulfilling similar assumptions.

The EMD system 200 comprises, among other features, a server 202, a client 218, and a distribution network 216 such as the Internet. When the client 218 wants to request content from a content provider, the client sends a request req to the server 202 over the network 216. For instance, the client 218 is an device for playing electronic music or video, for instance accessible via files in e.g. MP3 format, and the device, e.g. initiated by its user, requests a certain piece of music offered by a provider controlling server 202. A management processor 203 receives this request and authenticates the request in a known manner, for instance to ensure that the correct user is identified and/or debited for the subsequent download of the piece of music. Once authenticated, the content provider 204 sends the requested content 206, here in the form of a media signal x, to an encryption device 212. The encryption device 212 at least partially encrypts the content 206 using a first encryption key k₁, giving an at least partially encrypted media signal cₓ. In addition, the content provider 204 also sends the content information (media signal x) for the requested content to a watermark engine 210. The watermark engine 210 takes the content information and the userID from the requesting user and computes the appropriate payload to be embedded. The payload information signal w is then sent to an encryption device 214. The encryption device 214 then encrypts the payload information signal w at least partly using a second encryption key k₂, resulting in a partially encrypted watermark signal c_{w}. As will be described in more detail below, the server 202 can use a variety of methods for encrypting the content and the payload information. For instance, instead of using two encryption modules, the server 202 may use a single encryption device with at least two encryption keys. The server 202 then transmits the at least partially encrypted content cₓ and the at least partially encrypted watermark information signal c_{w} to the client 218 over the network 216, in an at least partially encrypted form, i.e. in a secure way.

The signals cₓ and c_{w} are received by a receiver 219 and are then combined in a watermark engine 220. The two at least partially encrypted signals cₓ and c_{w} are combined to generate a watermarked content in the encrypted domain. In other words, the client side watermark engine 220 performs the operation c_{y}=combine (cₓ, c_{w}).

The watermarked content c_{y} is then decrypted in a decryption device 222 using a third decryption key k₃. The decrypted data y from the decryption device 222 is the watermarked content only, i.e. the decrypted watermarked media signal y is generated by decrypting the encrypted combined media signal c_{y} using a third decryption key k3. The transmitted signal components x and w cannot be accessed by the client using the third decryption key k₃. As the user only has the key k3 to his disposal, he cannot manipulate the watermark, as components x and w are encrypted with k1 and k2, respectively, which are different from k3. However, decrypted signal y is a regular media signal that is watermarked and may be processed in a conventional way, e.g. in a user player unit 224.

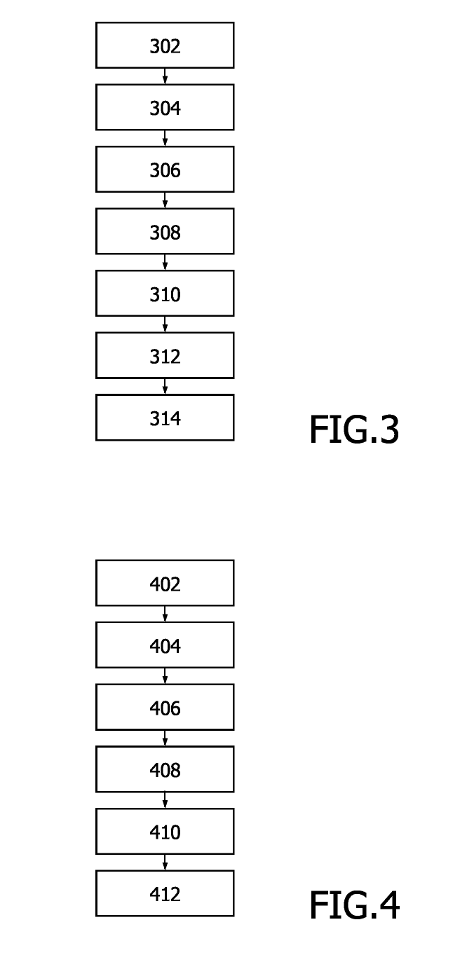

According to another embodiment of the invention, the encryption and decryption of the content and payload information will now be described using homomorphic cryptography using the Paillier method. FIG. 3 is a flow chart illustrating the homomorphic cryptography according to this embodiment of the invention. At the trusted server 202, the management processor 203, for example, selects two prime numbers p and q in step 302 and derives K=pq, N=LCM(p−1,q−1) where LCM is the least common multiplier in step 304. K and N are then supplied to the client 318. The management processor 203 then arbitrarily splits K as K=k1+k2 in step 306. For a positive integer r<K, the encryption device 212 now computes the at least partially encrypted content signal cₓ where

cₓ=(1+K)^{x}r^{k1} mod K² or (1)

cₓ=(1+K)^{x}r^{N.k1} mod K² (2)

in step 308. The encryption device 214 also computes the encrypted payload information signal c_{w} where c_{w}=(1+N)^{w}r^{k2} mod K² or c_{w}32 (1+N)^{w}r^{N.k1} mod K² in step 310.

After cₓ and c_{w} are transmitted to the client 218 over the network 216, the client 218 combines cₓ and c_{w} where c=c_{w}·cₓ=(1+N)^{w+x}r^{k1+k2} mod K² in step 312. The client 218 then uses the decryption key k3=K supplied to him to extract the watermarked content in step 314 using

$$y = \frac{( {c}^{N} - 1 ) \text{mod} k {3}^{2}}{Nk 3} \text{mod} k 3 \\ or \\ y = \frac{( c - 1 ) \text{mod} k {3}^{2}}{k 3} \text{mod} k 3 \qquad ( 3 )$$

Note that the relation given in (3) is a consequence of the following discrete mathematics identities. Given prime numbers p and q such that k3=p.q and N=LCM(p−1,q−1)

for any r<k3, r^{NK} mod k3²=1 mod k3² and

for any integer r<k3, (1+k3)^{a} mod k3²=(1+k3a) mod k3².

Thus, depending on the definition of cₓ in (1) and (2) c^{N}−1 mod k3²=(1+N)^{N(x+x)} r^{NK3} mod k3²=(1+Nk3(x+w)) mod k3² or c−1 mod k3²=(1+N)^{(x+x)} r^{Nk3} mod k3²=(1+k3(x+w)) mod k3². Putting this into (3), we get

$$y = \frac{( {c}^{N} - 1 ) \text{mod} k {3}^{2}}{Nk 3} \text{mod} k 3 = ( x + w ) \text{mod} k 3 \\ OR \\ y = \frac{( c - 1 ) \text{mod} k {3}^{2}}{k 3} \text{mod} k 3 = ( x + w ) \text{mod} k 3 \qquad ( 4 )$$

If x+w<k3, then (x+w) mod k3=x+w. Thus the client can decrypt the watermarked content. Since the client 218 does not know how k3 is split into k1 and k2, the client 218 can not decrypt the encrypted content signal and the encrypted payload information signal. In addition, the encrypted content signal can be broadcast. Each client (i) is then assigned a unique k2 (i.e., unique k3). The encrypted payload information signal is thus encrypted with this unique k2 so that only the client to whom the watermark is intended can decrypt x+w.

According to another embodiment of the invention, the encryption and decryption of the content and payload information will now be described using homomorphic cryptography using the El Gamal method. FIG. 4 is a flow chart illustrating the homomorphic cryptography according to this embodiment of the invention. At the trusted server 202, the management processor 203, for example, chooses random numbers r and k1 and g in step 402 and derives g and h₁=g^{k1} in step 404. The encryption device 212 then computes the encrypted content signal cₓ where cₓ=h₁^{r}g^{x} in step 406 and provides the pair (g^{r}, cₓ) to the client. The encryption device 214 then computes in step 408 the encrypted payload information signal c_{w} where c_{w}=h₂(i)^{r} g^{w} where for each client (i), the server chooses a k2(i) and a k(i)=k1+k2(i) and h₂(i)=g^{k2(i)} where k(i) is known to the client.

After (g^{r}, cₓ) and c_{w} are transmitted to the client 218 over the network 216, the client 218 combines cₓ and c_{w} in step 410 where c=c_{w}·cₓ=(h₁^{r}g^{x})·(h₂(i)^{r}g^{w})=h(i)^{r}·g^{x+w}, where h(i)^{r}=h₁^{r}·h₂(i)^{r}. The client then computes h(i)^{r}=(g^{r})^{k(i)} and decrypts x+w in step 412.

For the decryption the client performs the operation

$${g}^{x + w} = \frac{c}{{h ( i )}^{r}} = \frac{{h ( i )}^{r} {g}^{x + w}}{{h ( i )}^{r}} \qquad ( 5 )$$

where x+w is obtained by inverting the discrete exponential function g^{x+w}. Assuming x+w is of small word length (say in the order of 8-16 bits), the inverse is computed via a look up table (LUT).

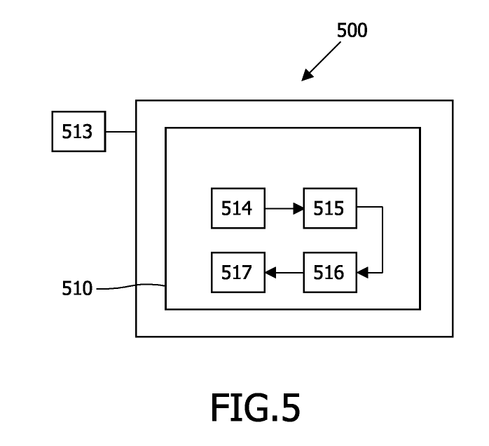

In another embodiment of the invention according to FIG. 5, a computer readable medium is illustrated schematically. A computer-readable medium 500 has embodied thereon a computer program 510 for embedding a watermark in a media signal in a device, for processing by a computer 513. The computer program 510 comprises a first code segment 514 for providing an at least partially encrypted media signal cₓ of said media signal x, wherein encryption is performed using a first encryption key k1; a second code segment 515 for providing an at least partially encrypted watermark signal c_{w}, wherein encryption is performed using a second encryption key k2; a third code segment 516 for combining the at least partially encrypted media signal cₓ and the at least partially encrypted watermark signal c_{w} in a combiner to obtain an encrypted combined media signal c_{y}; and a fourth code segment 517 for obtaining a decrypted watermarked media signal y by decrypting said encrypted combined media signal c_{y} using a third decryption key k3.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to specific embodiments, it is not intended to be limited to the specific form set forth herein. Rather, the invention is limited only by the accompanying claims and, other embodiments than the specific above are equally possible within the scope of these appended claims, e.g. different distribution systems than those described above.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method for embedding a watermark in a media signal x, comprising:
providing an at least partially encrypted media signal cₓ of said media signal x, wherein encryption is performed using a first encryption key k1;
providing an at least partially encrypted watermark signal c_{w}, wherein encryption is performed using a second encryption key k2;
combining the at least partially encrypted media signal cₓ and the at least partially encrypted watermark signal c_{w} in a combiner to obtain an encrypted combined media signal c_{y}; and
obtaining a decrypted watermarked media signal y by decrypting said encrypted combined media signal c_{y} using a third decryption key k3.

2. Method according to claim 1, wherein said combiner is a multiplier.

3. Method according to claim 1, wherein both a first watermark that is comprised in said at least partially encrypted watermark signal c_{w} and a second watermark of said decrypted watermarked media signal y are identical.

4. Method according to claim 1, wherein said third decryption key k3 differs from said first encryption key k1 and does not decrypt said at least partially encrypted media signal cₓ.

5. Method according to claim 1, wherein said third decryption key k3 differs from said second encryption key k2 and does not decrypt said at least partially encrypted watermark signal c_{w}.

6. Method according to claim 1, wherein said third decryption key k3 differs from said first encryption key k1 and said second encryption key k2.

7. Method according to claim 1, wherein said at least partially encrypted media signal cₓ is encrypted according to the relation:
cₓ=(1+K)^{x}r^{k1} mod K² or cₓ=(1+K)^{x}r^{N.k1} mod K²;
wherein N, K and r are positive integers and k1=K−k2 is said first encryption key.

8. Method according to claim 1, wherein said at least partially encrypted watermark signal c_{w} is encrypted according to the relation:
c_{w}=(1+K)^{w}r^{N.k2} mod K² or c_{w}=(1+K)^{w}r^{N.k2} mod K²;
wherein N, K and r are positive integers and k2=K−k1 is said second encryption key.

9. Method according to claim 1, wherein said obtaining a decrypted watermarked media signal y comprises computing:
$$y = \frac{( {c}_{y}^{N} - 1 ) \text{mod} k {3}^{2}}{Nk 3} \text{mod} k 3$$
$$or$$
$$y = \frac{( {c}_{y} - 1 ) \text{mod} k {3}^{2}}{k 3} \text{mod} k 3$$
wherein c_{y}=cₓc_{w}, N is a positive integer, and k3=k1+k2 is said third decryption key.

10. Method according to claim 1, wherein said at least partially encrypted media signal cₓ is encrypted according to the relation:
cₓ=g^{rk1}g^{x};
wherein g and r are positive integers and k1 is said first encryption key.

11. Method according to claim 1, wherein said at least partially encrypted watermark signal c_{w} is encrypted according to the relation: c_{w}=g^{rk2}g^{w};
wherein g and r are positive integers and k2 is said second encryption key.

12. Method according to claim 10, wherein said obtaining a decrypted watermarked media signal y comprises:
$${g}^{x + w} = \frac{{c}_{y}}{{g}^{rk 3}} ,$$
computing
wherein c_{y}=cₓc_{w}, r is a positive integer, and k3=k1+k2 is said third decryption key; and
solving the discrete exponential function g^{x+w} using a look up table to obtain the decrypted watermarked media signal y.

13. Method according to claim 1, wherein said method is performed in a device and wherein said device is an untrusted device having an untrusted environment, and/or wherein said providing said at least partially encrypted media signal cₓ of said media signal x comprises receiving said at least partially encrypted media signal cₓ of said media signal x in said device, and wherein said providing said at least partially encrypted watermark signal c_{w} comprises receiving said at least partially encrypted watermark signal c_{w} in said device.

14. The method according to claim 1, comprising independently providing said partially encrypted media signal cₓ and said partially encrypted watermark signal c_{w} at independent moments and via independent channels.

15. Method according to claim 1, wherein said method is performed in a software or program element and wherein said software or program element is running in an untrusted environment.

16. A system (200) for embedding a watermark in a media signal x, comprising:
means (219) for providing an at least partially encrypted media signal cₓ of said media signal x, wherein encryption is performed using a first encryption key k1;
means (219) for providing an at least partially encrypted watermark signal c_{w}, wherein encryption is performed using a second encryption key k2;
means (220) for combining the at least partially encrypted media signal cₓ and the at least partially encrypted watermark signal c_{w} in a combiner to obtain an encrypted combined media signal c_{y}; and
means (222) for obtaining a decrypted watermarked media signal y by decrypting said encrypted combined media signal c_{y} using a third decryption key k3.

17. A computer-readable medium having embodied thereon a computer program for embedding a watermark in a media signal x, for processing by a computer, the computer program comprising:
a first code segment for providing an at least partially encrypted media signal cₓ of said media signal x, wherein encryption is performed using a first encryption key k1;
a second code segment for providing an at least partially encrypted watermark signal c_{w}, wherein encryption is performed using a second encryption key k2;
a third code segment for combining the at least partially encrypted media signal cₓ and the at least partially encrypted watermark signal c_{w} in a combiner to obtain an encrypted combined media signal c_{y}; and
a fourth code segment for obtaining a decrypted watermarked media signal y by decrypting said encrypted combined media signal c_{y} using a third decryption key k3.

18. An encrypted combined media signal c_{y} comprising in combination
an at least partially encrypted media signal cₓ of a media signal x, wherein encryption is performed using a first encryption key k1, and
an at least partially encrypted watermark signal c_{w}, wherein encryption is performed using a second encryption key k2; wherein
said combination signal is decryptable in order to provide a decrypted watermarked media signal y by decrypting said encrypted combined media signal c_{y} using a third decryption key k3, such that said watermarked media signal y has a decrypted watermark embedded therein.

19. Use of the method according to claim 1 in an electronic music delivery (EMD) system (200).
